(19) United States
(12) Patent Application Publication
(10) Pub. No.: US 2014/0251851 A1
(43) Pub. Date: Sep. 11, 2014

(54) Pharmaceutical Warning System and Method

(71) Applicant: Susan B. Huntley, Red Bud, IL (US)

(72) Inventor: Susan B. Huntley, Red Bud, IL (US)

(21) Appl. No.: 13/791,990

(22) Filed: Mar. 9, 2013

(51) Int. Cl. B65D 51/24; A61J 1/00

(52) U.S. Cl. CPC B65D 51/248; A61J 1/00
USPC 206/459.1; 53/467

(57) ABSTRACT

Disclosed herein are various embodiments of a system and a method for pharmaceutical packaging with an audio warning and/or instruction. In accordance with one aspect of the approach, an sound generating pharmaceutical package includes a medical container having an interior space, a cover for preventing unauthorized access to the interior space, a sound module affixed to the medical container, the sound module containing a pre-recorded digital medical notice and a means for playing the digital warning; and a trigger mechanism configured to cause the sound module to play the medical notice when the cover is moved to allow access to the interior of the container.

### BACKGROUND

1. Field

This invention is generally related to pharmaceutical packaging, and in particular, to a system and method for providing pharmaceutical packaging with an audio warning and/or instruction.

2. Background

Various methods and systems related to pharmaceutical packaging are known to those having ordinary skill in the art. Various systems and methods are known in the art for providing audio messages with packaging, such as: U.S. Pat. No. 4,607,747, entitled, “Packaging for a Product as Well as Use of the Same,” issued to Steiner on Aug. 26, 1986; U.S. Pat. No. 6,545,594, entitled, “Audio Closure,” issued to Knight, et al., on Apr. 8, 2003; U.S. Pat. No. 7,183,936, entitled, “Closure Cap with Audible Warning,” issued to Ritson, on Feb. 27, 2007; the teachings of which are incorporated herein by reference.

Various systems and methods are also known in the art for providing audio messages or songs associated with greeting cards, such as: U.S. Pat. No. 5,063,698, entitled, “Greeting Card with Electronic Sound Recording,” issued to Johnston, et al., on Nov. 12, 1991; U.S. Pat. No. 8,176,663, entitled, “Electronic Greeting Cards and Novelties with Moveable Elements and Manual Electronic Circuit Activation,” issued to Sapp, et al, on May 15, 2012; the teachings of which are incorporated herein by reference

The known systems and methods are not optimal for providing pharmaceutical packaging with an audio warning and/or instruction.

### SUMMARY

Disclosed herein is a new and improved system and method for pharmaceutical packaging with an audio warning and/or instruction. In accordance with one aspect of the approach, a sound generating pharmaceutical package includes a medical container having an interior space, a cover for preventing unauthorized access to the interior space, a sound module affixed to the medical container, the sound module containing a pre-recorded digital medical notice and a means for playing the digital warning; and a trigger mechanism configured to cause the sound module to play the medical notice when the cover is moved to allow access to the interior of the container.

Other systems, methods, aspects, features, embodiments and advantages of the system and method for pharmaceutical packaging with an audio warning and/or instruction disclosed herein will be, or will become, apparent to one having ordinary skill in the art upon examination of the following drawings and detailed description. It is intended that all such additional systems, methods, aspects, features, embodiments and advantages be included within this description, and be within the scope of the accompanying claims.

### BRIEF DESCRIPTION OF THE DRAWINGS

Many aspects of the present disclosure can be better understood with reference to the following drawings. It is to be understood that the drawings are solely for purpose of illustration. Furthermore, the components in the figures are not necessarily to scale, emphasis instead being placed upon clearly illustrating the principles of the system and method disclosed herein. In the figures, like reference numerals designate corresponding parts throughout the different views.

FIG. 1 is a perspective view of a representative embodiment of cuboid med container with an opened end and a pull/push tab associated with an openable end.

FIG. 2 is the cuboid med container of FIG. 1 shown with the end closed.

FIG. 3 is a perspective view of a representative embodiment of bottle-shaped med container with an opened end.

FIG. 4 is a top view of the bottle-shaped med container of FIG. 3.

FIG. 5 is a perspective view of a representative embodiment of cuboid med container with an opened end, such as FIG. 1, that also includes a pull/push tab associated with a sealed end.

### DETAILED DESCRIPTION

The following detailed description, which references to and incorporates the drawings, describes and illustrates one or more specific embodiments. These embodiments, offered not to limit but only to exemplify and teach, are shown and described in sufficient detail to enable those skilled in the art to practice what is claimed. Thus, for the sake of brevity, the description may omit certain information known to those of skill in the art.

The disclosure and related inventions relate to medical containers (“med containers”), and in particular to sound generating med containers in which opening the container to access any contents of the med container, such as medications, is coordinated with a moveable or slidable member or piece which can be moved by manipulation relative to the opening of the container, and which is operatively connected to an electronic circuit within the med container to turn the electronic circuit on resulting in the delivery of an audio message. The sound generating med containers may be used to minimize the misuse contents of the med container by providing an automatic audio warning or instruction.

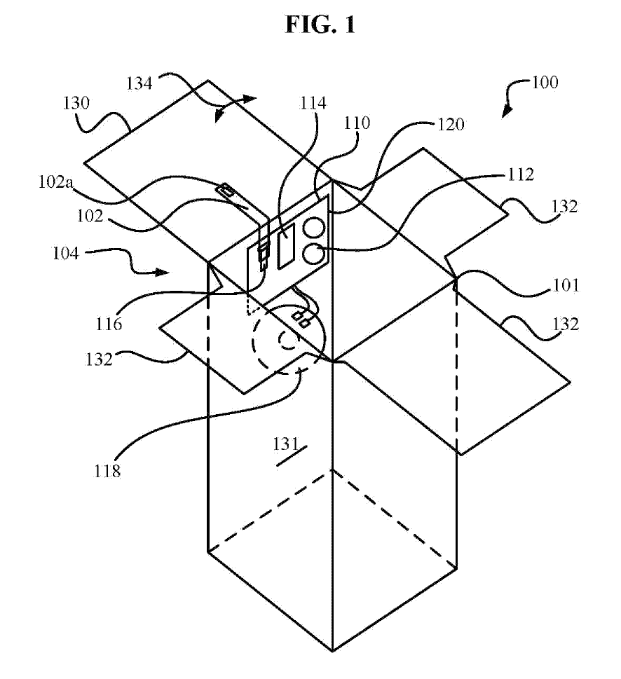

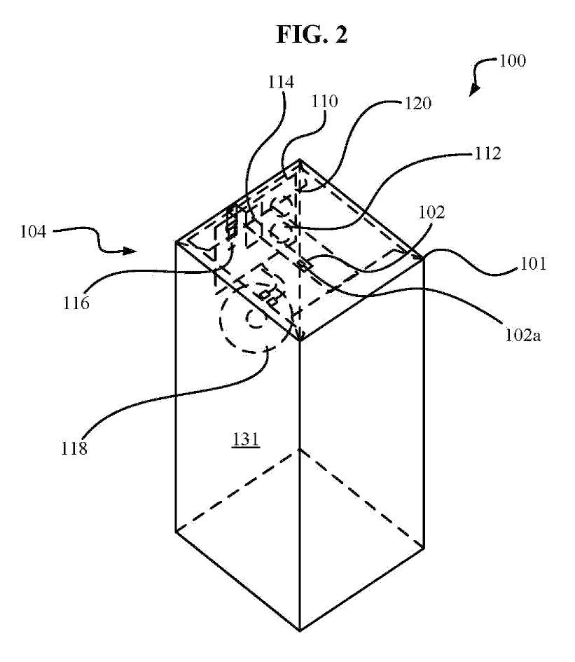

With reference to FIG. 1 and FIG. 2, shown is a representative med container embodiment in which the med container is shown as a cuboid med container 100 with an openable end 101. In FIG. 1, the cuboid med container 100 is shown in an open position. In FIG. 2, the cuboid med container 100 is shown in a closed position. A patient/user's input is used to control movement of a moveable member of the med container, which may be in the form of a tab or pull/push tab 102 which is constructed integral with the cuboid med container 100, such as mounted on an internal side or sides of a panel of the cuboid med container 100. Pulling, or pushing, on the pull/push tab 102 may activate an audio warning or instruction from a sound generating device 104 which is contained within, or otherwise attached, to the cuboid med container 100.

As shown in FIG. 1, the sound generating device 104 remains affixed to the cuboid med container 100, even when the openable end 101 is open, as shown in FIG. 1. When the pull/push tab 102 is pulled or extended to an extended position, and/or in other some embodiments pushed and contracted to a shortened position, a sound may be generated by the sound generating device 104 to which the pull/push tab 102 is connected. The prerecorded digital sound content of the sound generating device 104 can be coordinated with, or appropriate for, dangers and/or instructions associated with the contents of the med container.

In the representative embodiment shown in FIG. 1, the cuboid medical container 100 can be constructed from suitable paper, cardboard or plastic, and can be constructed in any particular size, shape or configuration suited to the contents (not shown) of the med container 100. In a particular embodiment, depicted in FIG. 1, the sound generating medical container 100 can be made with four side panels, a top panel 130, a bottom panel, and a plurality of top flaps 132. Top panel 130 may be hinged to a side panel 131, for example by creasing the cardboard, such that the interior of the cuboid medical container 100 can be accessed by swinging top panel 130 in the manner shown by arrow 134 in FIG. 1. The sound generating device 104 may be attached to the interior of panel 131 and pull/push tab 102 assembly may be secured to top panel 130, for example by adhesive 102a. The pull/push tab 102 may be integrated with the sound generating device 104 and near the top end of panel 131, so that the one end of the pull/push tab 102 is attached to top panel 130 and the other end is attached to a switch 116 associated with the sound generating device 104.

Accessing the interior of the cuboid medical container 100 by swinging end top panel 130 may cause a pulling of the pull/push tab 102 which may activate the sound generating device 104 to generate sound, such as for example by completion of a circuit on circuit board 120. The sound generated by a speaker 118 of the sound generating device 104 may be audible. The pre-recorded digital sound content can be of any type and may include a message appropriate for dangers and/or instructions associated with the medical substance and may supplement any additional warnings or instructions provided with, or on, the cuboid medical container 100.

The sound module may be, for example, a battery operated device of the types commercially available which include circuitry including an audio signal generating integrated circuit chip 114 with a digital memory storage device for storing preloaded digital audio data, a sound producing device in the form of the speaker 118, a battery power source 112, and the switch 116 for opening and closing electrical contact with the battery connection to the circuitry. The sound generating device 104 may include a circuit board 110, a battery source 112, the integrated circuit chip 114 with digital memory storage device, the switch 116, and the speaker 118. The sound generating device 104 may be secured to the inside surface of panel 131 by a conventional adhesive or other securing means. Although a particular placement of the sound generating device 104 is shown in this disclosure, it is understood that changes in placement, type and configuration of the sound module all within the scope of the disclosure and related inventions.

In a representative embodiment, the pull/push tab 102 operates the switch 116 associated with the circuit board 110 and the digital memory storage device 114 and thereby activates the speaker 118 causing sounds to be generated. The pull/push tab 102 may be made from coated paper stock, paper board, cardboard, plastic or the like, and may be connected to the switch 116 and the pull/push tab 102 by adhesives, glue, or the like. The pull/push tab 102 may be connected at one end to the switch 116 of sound module 104 and at the other end to the top panel 130. Actuation of the sound generating device 104 is accomplished by the closing of a power circuit control switch 116 (by movement of the pull/push tab 102) which energizes the digital memory storage device 114 from the battery power source 112 to cause the sound generating circuitry (including the memory storage device 114) to send sound generating signals to the speaker 118 in the cuboid medical container 100.

Although no particular warning or instruction is required in order to practice the invention, exemplar messages incuse, for example not not limited to, “For your safety, please read the enclosed warnings and directions before using this product” and messages specifically related to the proper, and/or improper use of the med container contents, and messages tailored to those who may be sight impaired. Messages may be available in multiple languages which may be selectable, or included in one recording that repeats in multiple languages.

Although the embodiments shown may be triggered by opening the med container in the manner contemplated, for example, the top of the med container, further embodiments include triggers that may be triggered by alternative methods of accessing the contents of the med container, for example, the message may be triggered by both the top panel and the bottom panel.

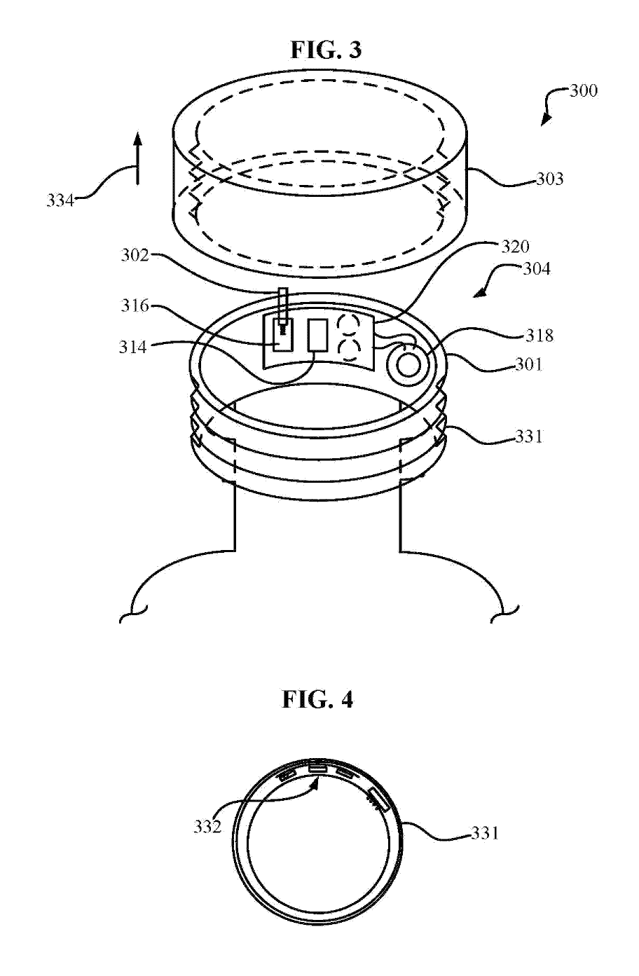

With reference to FIG. 3, shown is a representative med container embodiment in which the med container is shown as a bottle-shaped med container 300 with an openable end 301 and a cap 303 that may be affixed to the end 301. In FIG. 3, the bottle-shaped med container 300 is shown in an open position. A patient/user's input is used to control movement of a moveable member of the med container, which may be in the form of a spring loaded knob 302 which is constructed integral with the bottle-shaped med container 300, such as mounted on an internal side or sides of a neck of the bottle-shaped med container 300. Pulling, or pushing, on the spring loaded knob 302 may activate an audio warning or instruction from a sound generating device 304 which is contained within, or otherwise attached, to the bottle-shaped med container 300.

As shown in FIG. 3, the sound generating device 304 remains affixed to the bottle-shaped med container 300, even when the openable end 301 is open, as shown in FIG. 3. When the spring loaded knob 302 is extended position, for example by being released when the cap 303 is removed from the openable end 301, a sound may be generated by the sound generating device 304 to which the spring loaded knob 302 is connected. The prerecorded digital sound content of the sound generating device 304 can be coordinated with, or appropriate for, dangers and/or instructions associated with the contents of the med container.

In the representative embodiment shown in FIG. 3, bottle-shaped med container 300 can be constructed from suitable plastic and can be constructed in any particular size, shape or configuration suited to the contents (not shown) of the med container 300. Cap 303 may be removed by twisting the cap and lifting in the direction shown by arrow 334 in FIG. 3. The sound generating device 304 may be attached to the interior of a neck 331 of the med container 300, and spring loaded knob 302 may be secured to mounted in the neck 331 such that it extends beyond the neck 331 when the cap 303 is removed and the spring is allowed to expand. The spring loaded knob 302 may be integrated with the sound generating device 304 and near the top end of neck 331, so that the one end of the spring loaded knob 302 is in contact with the cap 303 when the cap 303 is on the med container, and therefore the spring is compressed, and the other end is attached to a switch 316 associated with the sound generating device 304.

Accessing the interior of the bottle-shaped med container 300 by removing cap 303 may cause an extension of the spring loaded knob 302 which may activate the sound generating device 304 to generate sound, such as for example by completion of a circuit on circuit board 320. The sound generated by a speaker 318 of the sound generating device 304 may be audible.

The sound module may be, for example, a battery operated device of the type which include circuitry including an audio signal generating integrated circuit chip 314 with a digital memory storage device for storing preloaded digital audio data, a sound producing device in the form of the speaker 318, a battery power source 312, and the switch 316 for opening and closing electrical contact with the battery connection to the circuitry. The sound generating device 304 may include a circuit board 310, a battery source 312, the integrated circuit chip 314 with digital memory storage device, the switch 316, and the speaker 318. The sound generating device 304 may be secured to the neck 331, and may be concealed behind a barrier 332, such as shown in FIG. 4. Although a particular placement of the sound generating device 304 is shown in this disclosure, it is understood that changes in placement, type and configuration of the sound module all within the scope of the disclosure and related inventions.

In a representative embodiment, the spring loaded knob 302 operates the switch 316 associated with the circuit board 310 and the digital memory storage device 314 and thereby activates the speaker 318 causing sounds to be generated. The spring loaded knob 302 may be made from plastic or the like, and may be connected to the switch 316. Actuation of the sound generating device 304 is accomplished by the closing of a power circuit control switch 316 (by movement of the spring loaded knob 302) which energizes the digital memory storage device 314 from the battery power source 312 to cause the sound generating circuitry (including the memory storage device 314) to send sound generating signals to the speaker 318 in bottle-shaped med container 300.

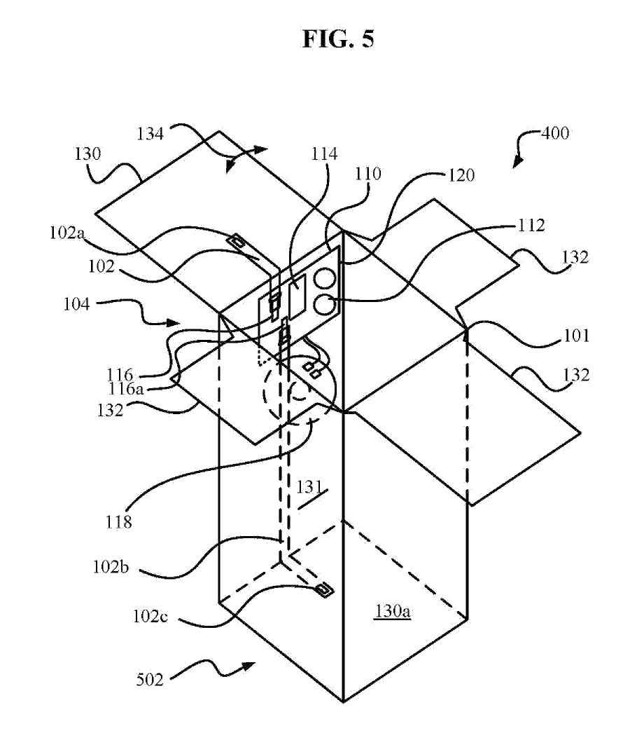

FIG. 5 is a perspective view of the cuboid med container 400 with the openable end 101 of FIG. 1, that also includes a second pull/push tab 102b associated with a sealed end 502 of the container 100. The sealed end 502 may include a bottom panel 130a. Pull/push tab 102b assembly may be secured to bottom panel 130a, for example by adhesive 102c. The pull/push tab 102b may be integrated with the sound generating device 104 near the top end of panel 131, so that the one end of the pull/push tab 102b is attached to bottom panel 130a, and the other end is attached to a switch 116a associated with the sound generating device 104. Thus, the cuboid medical container 100, as shown in FIG. 5, may provide an alarm when the container 100 is improperly opened at the sealed end 502.

Described herein are embodiments that provide a sound generating pharmaceutical package that includes a medical container, for example, the cuboid medical container 100, having an interior space. The package also may include a cover, for example top panel 130, for preventing unauthorized access to the interior space. The package may also include a sound module, for example sound module 104, affixed to the medical container, the sound module containing a pre-recorded digital medical notice and a means for playing the digital warning. The package may also include a trigger mechanism, for example, the pull/push tab 102, the trigger mechanism configured to cause the sound module to play the medical notice when the cover is moved to allow access to the interior of the container.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make and use the invention, and not necessarily to limit the scope of legal protection afforded the appended claims.

The above description of the disclosed embodiments is provided to enable any person skilled in the art to make or use that which is defined by the appended claims. The following claims are not intended to be limited to the disclosed embodiments. Other embodiments and modifications will readily occur to those of ordinary skill in the art in view of these teachings. Therefore, the following claims are intended to cover all such embodiments and modifications when viewed in conjunction with the above specification and accompanying drawings. All such modifications and variations are intended to be included herein within the scope of this disclosure and protected by the following claims.

What is claimed is:

1. A sound generating pharmaceutical package comprising:
a medical container having an interior space;
a cover for preventing unauthorized access to the interior space;
a sound module affixed to the medical container, the sound module containing a pre-recorded digital medical notice and a means for playing the digital warning; and
a trigger mechanism, the trigger mechanism configured to cause the sound module to play the medical notice when the cover is moved to allow access to the interior of the container;

2. The package of claim 1, wherein the sound module remains affixed to the medical container when the interior space is accessed, such that the sound module will be activated even if a replacement cover is used with the medical container.

3. The package of claim 1, wherein the medical container is cuboid.

4. The package of claim 1, wherein the medical container is bottle-shaped.

5. The package of claim 1, wherein the trigger mechanism includes a pull/push tab.

6. The package of claim 1, wherein the sound module also play the medical notice when a normally sealed end is opened.

7. A method for packaging pharmaceuticals, the method including the steps of:
forming a medical container having a sound module affixed to the medical container, the sound module containing a pre-recorded digital medical notice and a means for playing the digital warning;
incorporating a trigger mechanism in the medical container, the trigger mechanism configured to cause the sound module to play the medical notice when a cover is moved to allow access to an interior space of the container;
placing pharmaceuticals in the interior space of the medical container; and
covering the medical container with the cover in order to prevent unauthorized access to the interior space;
wherein the sound module remains affixed to the medical container when the interior space is accessed, such that the sound module will be activated even if a replacement cover is used with the medical container.

8. The method of claim 6, wherein the medical container is bottle-shaped.
